(19) United States
(12) Patent Application Publication
(10) Pub. No.: US 2019/0205937 A1
(43) Pub. Date: Jul. 4, 2019

(54) INFORMATION PRESENTATION SYSTEM

(71) Applicant: Mitsubishi Electric Corporation, Chiyoda-ku (JP)

(72) Inventors: Yoshihisa YAMAGUCHI, Tokyo (JP); Hiroki KONAKA, Tokyo (JP); Kazuyo YOSHIMURA, Tokyo (JP)

(73) Assignee: Mitsubishi Electric Corporation, Chiyoda-ku (JP)

(21) Appl. No.: 16/323,034

(22) PCT Filed: Sep. 27, 2016
(86) PCT No.: PCT/JP2016/078327

§ 371 Date: Feb. 4, 2019

(51) Int. Cl. G06Q 30/02; G06K 9/00; G09F 21/04

(52) U.S. Cl. CPC G06Q 30/0266; G09F 21/04; G06K 9/00832

(57) ABSTRACT

The present invention relates to an information presentation system. A vehicle includes a data processing transfer unit configured to set a load distribution plan to distribute data processing to the vehicle and the server based on a state of the vehicle, a state of the server, and a state of the network, a first line of sight detection unit configured to detect a line of sight of the passenger based on the in-vehicle image, a first advertisement detection unit configured to specify the advertisement viewed by the passenger based on the line of sight of the passenger and the external image, a database in which an appearance pattern and the provided information of the advertisement are stored, and an information output unit configured to output the provided information stored in the database. A server includes a second line of sight detection unit configured to detect a line of sight of the passenger based on the in-vehicle image, and a first advertisement detection unit configured to specify the advertisement viewed by the passenger based on the line of sight of the passenger and the external image, the first and second advertisement detection units are configured to perform matching between the external image and the appearance pattern of the advertisement stored in the database to specify the advertisement viewed by the passenger.

### TECHNICAL FIELD

The present invention relates to an information presentation system, particularly to an information presentation system configured to present information related to an advertisement viewed by a passenger of a vehicle.

### BACKGROUND ART

As an information presentation system mounted on a vehicle, a device having the function of detecting a line of sight of a passenger and presenting the information of an object the passenger is paying attention to has been developed. For example, Patent Document 1 discloses a technique of calculating a crossing position of the line of sight of the passenger and the windshield and displaying, in response to an operation by a user, the information of the object presenting in a direction of the line of sight of the passenger at the crossing position of the windshield.

Also, Patent Document 2 discloses a technique of detecting an advertisement presenting in a direction of a line of sight of a passenger and presenting advertisements meeting the passenger's preference based on bio-information obtained when the passenger sees the advertisement, with audio and images.

### PRIOR ART DOCUMENTS

### Patent Documents

[Patent Document 1] Japanese Patent No. 3920580

[Patent Document 2] Japanese Patent Application Laid-Open No. 2014-52518

### SUMMARY

### Problem to be Solved by the Invention

As described above, in the case where the information of the object the passenger is paying attention to is presented by detecting the line of sight of the passenger and in the case where the advertisement meeting the preference of the passenger is presented, in either cases, there has been a problem of taking time in presentation of information, because, from analysis processing of a line of site of a user to presentation of information, information to be processed is huge.

The present invention has been made to solve the above-mentioned problem and has an object of the present invention to provide an information presentation system in which the processing time from analysis processing of a line of site of a user to presentation of information is shortened.

### Means to Solve the Problem

According to the present invention, an information presentation system configured to present provided information related to an advertisement outside a vehicle viewed by a passenger of the vehicle, the information presentation system being configured to transfer and receive data through a network between the vehicle and the server provided outside the vehicle, the vehicle including an external image input unit to which an external image is input, an in-vehicle image input unit to which an in-vehicle image is input, a data processing transfer unit configured to set a load distribution plan to distribute data processing to the vehicle and the server based on a state of the vehicle, a state of the server, and a state of the network, a first line of sight detection unit configured to detect a line of sight of the passenger based on the in-vehicle image acquired from the in-vehicle image input unit, a first advertisement detection unit configured to specify the advertisement viewed by the passenger based on the line of sight of the passenger and the external image and a parameter of the external image acquired from the external image input unit, a database in which an appearance pattern and the provided information of the advertisement are stored, and an information output unit configured to output the provided information stored in the database, the server including a second line of sight detection unit configured to detect a line of sight of the passenger based on the in-vehicle image acquired from the in-vehicle image input unit, and a second advertisement detection unit configured to specify the advertisement viewed by the passenger based on the line of sight of the passenger and the external image acquired from the external image input unit.

### Effects of the Invention

Based on a state of a vehicle, a state of a server, and a state of a network, data processing is executed by distributing a load between the inside of the vehicle and the server, therefore, the processing time from the detection of the line of sight of the passenger to the presentation of the provided information relating to the advertisement outside the vehicle is shortened.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 A block diagram illustrating a configuration of an information presentation system according to Embodiment 1 of the present invention.

FIG. 2 A block diagram illustrating a configuration of hardware of respective processing parts for a vehicle in the information presentation system according to Embodiment 1 of the present invention.

FIG. 3 A block diagram illustrating a configuration of hardware of respective processing parts for a vehicle in the information presentation system according to Embodiment 1 of the present invention.

FIG. 4 A flowchart illustrating transfer processing in a data processing transfer unit.

FIG. 5 A flowchart illustrating line of sight detection processing in a line of sight detection unit.

FIG. 6 A flowchart illustrating advertisement detection processing in an advertisement detection unit.

FIG. 7 A table illustrating an example of data stored in an advertisement database.

FIG. 8 A block diagram illustrating a configuration of an information presentation system according to Embodiment 2 of the present invention.

FIG. 9 A block diagram illustrating a configuration of hardware of respective processing parts for a vehicle in the information presentation system according to Embodiment 2 of the present invention.

FIG. 10 A block diagram illustrating a configuration of an information presentation system according to Embodiment 3 of the present invention.

FIG. 11 A block diagram illustrating a configuration of hardware of respective processing parts for a vehicle in the information presentation system according to Embodiment 3 of the present invention.

FIG. 12 A table illustrating an example of a specification plan.

### DETAILED OF EMBODIMENT(S)

### Introduction

In the following description, the term “passenger” includes an occupant in a passenger seat and occupants in back seats as well as a driver of the vehicle, and also includes occupants of a vehicle such as a bus in which multiple occupants are present.

### Embodiment 1

### Device Configuration

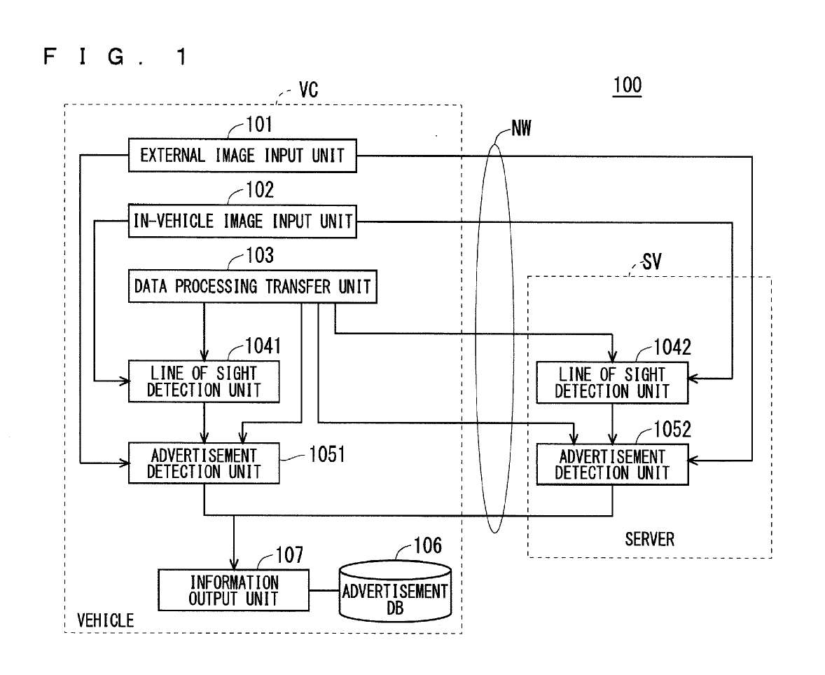

FIG. 1 is a block diagram illustrating a configuration of an information presentation system according to Embodiment 1 of the present invention. As illustrated in FIG. 1, the information presentation system 100, a vehicle VC includes an external vehicle image input unit 101, an in-vehicle image input unit 102, data processing transfer unit 103, a line of sight detection unit 1041 (first line of sight detection unit), an advertisement detection unit 1051 (first advertisement detection unit), an advertisement database (DB) 106, and an information output unit 107 as a configuration thereof. In addition, an external server SV includes a line of sight detection unit 1042 (second line of sight detection unit) and an advertisement detection unit 1052 (second advertisement detection unit) as a configuration thereof. The server SV is an outside the vehicle infrastructure server such as a VICS (registered trademark: vehicle information and communication system) center, and the configuration of the vehicle VC and the configuration of the server SV transfer and receive information (data) through a network NW such as the Internet.

The external vehicle image input unit 101 acquires parameters of the image (external vehicle image) around the vehicle VC on which a passenger rides, and outputs the parameters to the advertisement detection units 1051 and 1052. As a basic configuration, a camera, which is mounted on the vehicle VC, for photographing the front of the vehicle is included, and acquires an image outside the vehicle in real time when the information presentation system 100 is in operation. Further, the parameters of the external vehicle image include at least information of the photographing position and the photographing direction of the external vehicle image. In addition to this, information on cameras, lenses, and images such as the number of pixels of the image, the angle of view, the focal length of the lens, the diaphragm value (F value) of the lens, the image distortion information, and the like may be included. If the image range is fixed, a system developer may set the parameters of the image in advance, however, dynamic changes like the orientation of the camera and zoom etc. are allowed, the value at the time of image photographing may be acquired.

A camera installed in the vehicle may include a camera that photographs other than the front, such as a camera using a wide angle lens capable of simultaneously photographing the front and sides of the vehicle and a camera using a fisheye lens that photographs the entire circumference of the vehicle at the same time. In addition, when an occupant has a difficulty in seeing the front of the vehicle, for example, in a vehicle having a long body such as a sightseeing bus and a vehicle in which the front portion and the rear portion of the vehicle are separated, the camera may be installed for photographing the sides thereof.

Alternatively, a configuration may be adopted in which images of a plurality of cameras are synthesized into one image. For example, it may be configured to input a wider range of images than that of photographed by one camera by installing cameras toward 45 degrees diagonally to the right front and 45 degrees diagonally to the left front and combining the acquired images.

Further, a configuration may be adopted in which images other than those captured in real time, such as preliminarily captured images and synthesized images by computer graphics (CG), are also input.

The in-vehicle image input unit 102 acquires the image (in-vehicle image) of the inside of the vehicle VC on which the passenger to ride and the parameters of the in-vehicle image and outputs thereof to the line of sight detection units 1041 and 1042. As a basic configuration, a camera, which is mounted on the vehicle VC, for photographing the face of the passenger is included, and acquires an image inside the vehicle in real time when the information presentation system 100 is in operation. Further, the parameters of the in-vehicle image include at least information of the photographing position and the photographing direction of the in-vehicle image. In addition to this, information on cameras, lenses, and images such as the number of pixels of the image, the angle of view, the focal length of the lens, the diaphragm value (F value) of the lens, the image distortion information, and the like may be included. If the image range is fixed, a system developer may set the parameters of the image in advance, however, dynamic changes like the orientation of the camera and zoom etc. are allowed, the value at the time of image photographing may be acquired.

The camera for the inside of the vehicle may be a camera using a fisheye lens that photographs all passengers at once. Alternatively, a configuration may be adopted in which images of a plurality of cameras are synthesized into one image. Further, a configuration may be adopted in which images other than those captured in real time, such as preliminarily captured images and synthesized images by computer graphics (CG), are also input.

Further, a configuration may be adopted in which images other than those captured in real time, such as preliminarily captured images and synthesized images by computer graphics (CG), are also input.

Based on the states of the vehicle VC, the server SV and the network NW (communication), the data processing transfer unit 103 set a plan for distribution processing for the line of sight detection processing and the advertisement detection processing to the vehicle VC and the server SV. Here, the execution assignment of the line of sight detection processing and the advertisement detection processing is referred to as a load distribution plan, and the load distribution plan is output to the line of sight detection units 1041 and 1042 and the advertisement detection units 1051 and 1052.

The line of sight detection units 1041 and 1042 detect the line of sight of the passenger by using the in-vehicle image and the parameters of the in-vehicle image acquired by the in-vehicle image input unit 102, and output the line-of-sight information to the respective advertisement detection units 1051 and 1052. The line of sight detection unit 1041 executes the line of sight detection processing in the vehicle VC, and the line of sight detection unit 1042 executes the line of sight detection processing in the server SV outside the vehicle VC.

A method of detecting the line of sight includes various methods such as a method of measuring the reflected light from an in-vehicle image by illuminating the cornea of the passenger and a method of detecting the irises of the passenger from the in-vehicle image. In Japanese Patent Application Laid-Open No. 7-156712, for example, discloses a technique of photographing the face of the passenger by a visible camera and an infrared camera, thereby identifying the locations of the passenger's eyes from an infrared image and identifying the locations of the passenger's inner and outer corners of the eyes from a visual image. Also, in Japanese Patent Application Laid-Open No. 4-225478 discloses a technique of detection of a line of sight by extracting the irises of eyes by edge detection. In the present invention, any known method is adopted for detection of a line of sight as long as the line-of-sight information to be obtained includes at least information of a starting point of the line of sight and information of a direction of the line of sight. Also, information about the eyes of the passenger such as a position of head or positions of eyes of the passenger, a direction of face or directions of irises, the number of blinks, and whether or not the passenger wears a pair of glasses or contact lenses are acquired and they may be included in the line-of-sight information.

The advertisement detection units 1051 and 1052 specify the advertisement (viewed object) being viewed by the passenger by using the external image and the parameters of the external image acquired by the external image input unit 101, pieces of line-of-sight information of the passenger acquired by the respective line of sight detection units 1041 and 1042.

The advertisement detection unit 1051 executes the advertisement detection processing in the vehicle VC, and the advertisement detection unit 1052 executes the advertisement detection processing in the server SV. In the advertisement detection processing, detailed information on the viewed object is read from the advertisement database (DB) 106 and through the information output unit 107, the read information is presented to the passenger by a method the passenger can recognize.

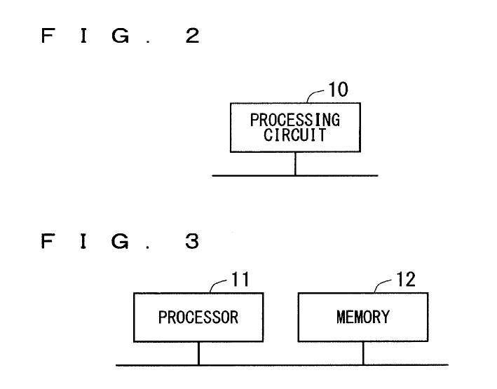

Each configuration (the data processing transfer unit 103, the line of sight detection unit 1041, and the advertisement detection unit 1051) on the vehicle VC of the information presentation system 100 illustrated in FIG. 1 is realized by the processing circuit 10 illustrated in FIG. 2, for example. Specifically, the processing circuit 10 includes the advertisement detection unit 1051 configured to detect information related to the advertisement viewed by the passenger by using, based on states of the vehicle VC, the server SV and the network NW, the data processing transfer unit 103 for setting a plan for distribution processing for the line of sight detection processing and the advertisement detection processing to the vehicle VC and the server SV, the line of sight detection unit 1041 for detecting the line of sight of the passenger by using the in-vehicle image and the parameters of the in-vehicle image acquired by the in-vehicle image input unit 102, the external image and the parameters of the external image acquired by the external vehicle image input unit 101, and the line-of-sight information of the passenger acquired by the line of sight detection unit 1041.

A dedicated hardware may be applied to the processing circuit 10, and a processor executing a program stored in a memory such as a Central Processing Unit (CPU) and a Digital Signal Processor (DSP) may also be applied to the processing circuit 10.

When a dedicated hardware is applied to the processing circuit 10, a single circuit, a composite circuit, a programmed processor, a parallel programed processor, an ASIC, an FPGA, and combinations thereof correspond to the processing circuit 10.

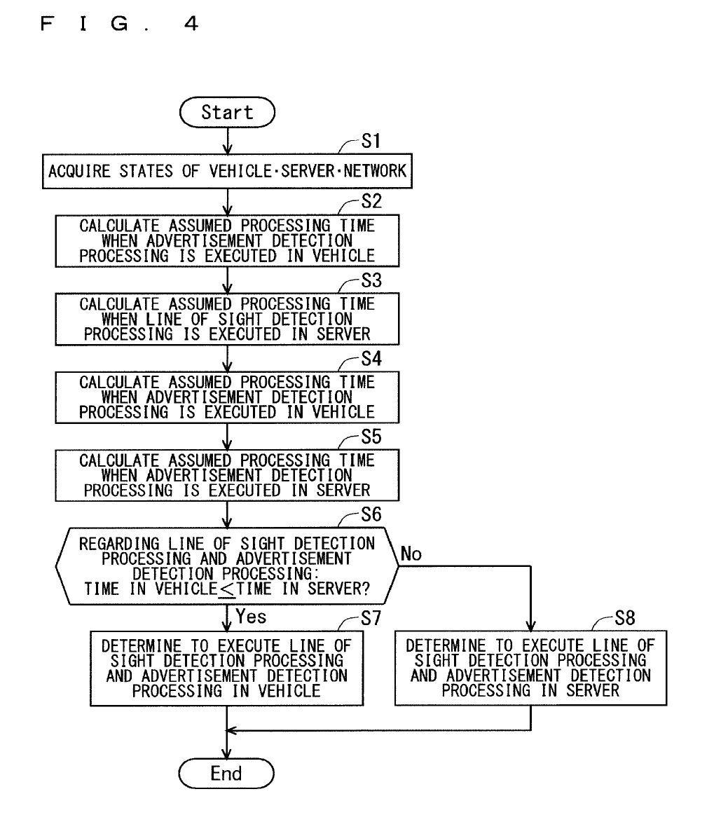

FIG. 3 illustrates a configuration of hardware when each configuration (the data processing transfer unit 103, the line of sight detection unit 1041, and the advertisement detection unit 1051) of the vehicle VC of the information presentation system 100 is configured by a processor. In this case, the function of each configuration of the vehicle VC of the information presentation system 100 is realized by a combination with a software and so forth (a software, a firmware, or a software and a firmware). The software and so forth are written as programs and stored in a memory 12. A processor 11 that functions as the processing circuit 10, reads and runs the programs stored in the memory 12, thereby each of the functions is realized.

Here, a nonvolatile or volatile semiconductor memory such as Random Access Memory (RAM), Read Only Memory (ROM), flash memory, Erasable Programmable Read Only Memory (EPROM), Electrically Erasable Programmable Read Only Memory (EEPROM), and a Hard Disk Drive (HDD), a magnetic disk, a flexible disk, an optical disk, a compact disk, a minidisk, Digital Versatile Disc (DVD), and a drive device thereof and so forth correspond to the memory 12.

Further, each configuration (the line of sight detection unit 1042 and the advertisement detection unit 1052) of the server SV of the information presentation system 100 illustrated in FIG. 1 is also realized by a processing circuit similar to the processing circuit 10 illustrated in FIG. 2, a dedicated hardware may be applied to the processing circuit, and a processor executing a program stored in a memory may also be applied to the processing circuit.

Also, the configuration of hardware that is similar to the processor 11 and the memory 12 as illustrated in FIG. 3 is also applicable to a configuration of hardware in which each configuration (the line of sight detection unit 1042 and the advertisement detection unit 1052) of the server SV of the information presentation system 100 is configured by a processor.

### Processing in the Data Processing Transfer Unit

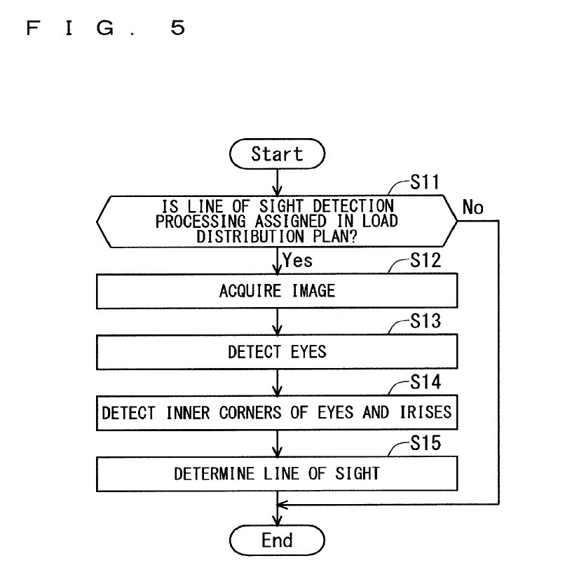

Next, transfer processing of the data processing transfer unit 103 will be described with reference to a flowchart illustrated in FIG. 4.

When the processing at the data processing transfer unit 103 starts, first, the data processing transfer unit 103 acquires the states of the vehicle VC, the server SV, and the network NW (communication) (step S1). The state of the vehicle VC acquired by the data processing transfer unit 103 includes an upper limit of the processing capacity of the CPU in the vehicle VC, a processing capacity of the CPU having a margin in the processing capacity within the current vehicle VC, an upper limit of the storage capacity of the memory in the vehicle VC usable in the transfer processing, a storage capacity of the memory in the storage capacity of the current vehicle VC, presence or absence of processes and programs in the vehicle VC operating in parallel with the transfer processing, CPU load state and memory load state and so forth. The data processing transfer unit 103 uses any one of those factors above, or a combination of a plurality of above factors as the state of the vehicle VC.

The state of the server SV acquired by the data processing transfer unit 103 includes an upper limit of the processing capacity of the CPU in the server SV, a processing capacity of the CPU having a margin in the processing capacity within the current server SV, an upper limit of the storage capacity of the memory in the server SV usable in the transfer processing, a storage capacity of the memory in the storage capacity of the current server SV, presence or absence of processes and programs in the server SV operating in parallel with the transfer processing, CPU load state and memory load state and so forth. The data processing transfer unit 103 uses any one of those factors above, or a combination of a plurality of above factors as the state of the server SV.

The state of the communication (network NW) acquired by the data processing transfer unit 103 includes an upper limit of the communication speed, a communication amount used currently, other processing, and program and the current communication speed, and one-way or a round-trip communication time between the current vehicle VC and the server SV. The data processing transfer unit 103 uses any one of those factors above, or a combination of a plurality of above factors as the state of communication.

Next, the data processing transfer unit 103 calculates an assumed processing time when the line of sight detection processing is executed in the vehicle VC by using the state of the vehicle VC acquired in step S1 (step S2).

For example, when it is assumed that the processing amount required for transfer processing is 500 [% sec] and the currently usable processing capacity of the CPU in the vehicle VC acquired in step S1 is 100%, it takes 500÷100=5 [sec] in the assumed processing time. Here, the processing capacity of the CPU indicates CPU usage which is generally expressed by Million Instructions Per Second (MIPS), however, it is expressed in the present application by a unit [% sec] for the sake of simplicity. 500 [% sec] corresponds to the processing amount to be processed in five seconds when the CPU usage is 100%. For example, with the CPU having the processing capacity of 3750 MIPS, the processing amount of 3750×5=18750 [MI] corresponds to 500 [% sec]. Also, in the following description, the expression that the processing capacity of the CPU is 200% is used and this assumes a case where one CPU has two cores. When one core is fully operating, the CPU has a processing capacity (usage rate) of 100% while when two cores are fully operating, the CPU has a processing capacity (usage rate) of 200%.

Next, the data processing transfer unit 103 calculates an assumed processing time when the line of sight detection processing is executed in the server SV by using the state of the server SV acquired in step S1 (step S3).

For example, when it is assumed that the processing amount required for line of sight detection processing is 500 [% sec] and the currently usable processing capacity of the CPU in the server SV acquired in step S1 is 200%, it takes 500÷200=2.5 [sec] in the assumed processing time. And when it takes 2 [sec] for the round-trip communication time between the vehicle VC and the server SV acquired in step S1, it takes 2.5+2=4.5 [sec] to complete the processing, therefore, time necessary for communication is taken into consideration.

Next, the data processing transfer unit 103 calculates an assumed processing time when the advertisement detection processing is executed in the vehicle VC by using the state of the vehicle VC acquired in step S1 (step S4).

For example, when it is assumed that the processing amount required for the advertisement detection processing is 1000 [% sec] and the currently usable processing capacity of the CPU in the vehicle VC acquired in step S1 is 100%, it takes 1000÷100=10 [sec] in the assumed processing time.

Next, the data processing transfer unit 103 calculates an assumed processing time when the advertisement detection processing is executed in the server SV by using the state of the server SV acquired in step S1 (step S5).

For example, when it is assumed that the processing amount required for the advertisement detection processing is 1000 [% sec] and the currently usable processing capacity of the CPU in the server SV acquired in step S1 is 200%, it takes 1000÷200=5 [sec] in the assumed processing time. And when it takes 2 [sec] for the round-trip communication time between the vehicle VC and the server SV acquired in step S1, it takes 5+2=7 [sec] to complete the processing, therefore, time necessary for communication is also taken into consideration.

Next, the data processing transfer unit 103 compares the sum of assumed processing times in the vehicle VC calculated in steps S2 and S4 with the sum assumed processing times in the server SV calculated in steps S3 and S5 (step S6). And when the result is that the processing time in the vehicle VC is equal to or lower than the processing time in the server SV, the step proceeds to step S7, while when the result is that the processing time in the vehicle VC exceeds the processing time in the server SV, the step proceeds to step S8.

That is, when the processing time in the vehicle VC is equal to or lower than the processing time in the server SV, the data processing transfer unit 103 determines a load distribution plan of execution of the line of sight detection processing and the advertisement detection processing in the vehicle VC (step S7). Therefore, the line of sight detection processing is executed in the line of sight detection unit 1041 and the advertisement detection processing is executed in the advertisement detection unit 1051. That is, when the processing time in the vehicle VC exceeds the processing time in the server SV, the data processing transfer unit 103 determines a load distribution plan of execution of the line of sight detection processing and the advertisement detection processing in the server SV (step S8). Therefore, the line of sight detection processing is executed in the line of sight detection unit 1042 and the advertisement detection processing is executed in the advertisement detection unit 1052.

The data processing transfer unit 103 performs determination in step S7 or step S8, then completes a series of processes of the transfer processing, and waits until the transfer processing is started next. It should be noted that, the data processing transfer unit 103 has a configuration in which the transfer processing is repeated on a regular bases during the information presentation system 100 is in operation, and the timing of starts thereof may be synchronized with the timing at which an image and parameters of the image are acquired by the external image input unit 101 and the in-vehicle image input unit 102, for example.

It should be noted that, an example in which, based on the states of the vehicle VC, the server SV and the network NW (communication), the data processing transfer unit 103 determines a load distribution plan is described above, not all of the three states may not necessarily be taken into consideration. For example, if there is no problem in the state of the network NW, that is, when the communication time is shorter than a predetermined time, for example, 10 msec., the state of the network NW need not be taken into consideration.

### Processing of the Line of Sight Detection Unit

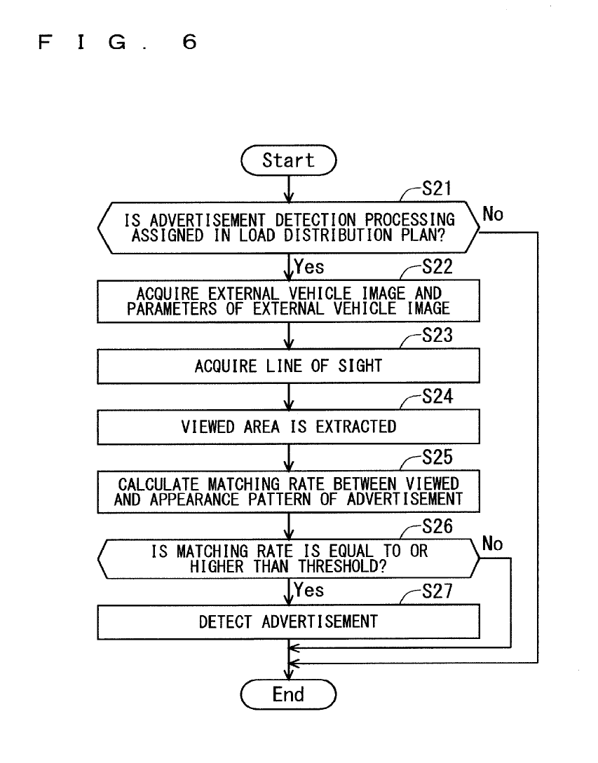

Next, line of sight detection processing by the line of sight detection units 1041 and 1042 will be described with reference to a flowchart illustrated in FIG. 5. Operation performed in each of the line of sight detection units 1041 and 1042 is the same; therefore, the line of sight detection unit 1041 will be described below as an example.

The line of sight detection unit 1041 first acquires the load distribution plan from the data processing transfer unit 103, and determines, in the load distribution plan, whether or not the line of sight detection processing is assigned to the line of sight detection unit 1041 (step S11). When the result of determination is that the line of sight detection processing is assigned thereto, the step proceeds to step S12 whereas the line of sight detection processing is not assigned thereto, steps after step S12 are not executed and the processing is ended. This signifies that, of the line of sight detection units 1041 and 1042, only one of the units which is assigned the line of sight detection processing in the load distribution plan executes the line of sight detection processing.

In step S12, the line of sight detection unit 1041 acquires the in-vehicle image and the parameters of the in-vehicle image from the in-vehicle image input unit 102.

Next, the line of sight detection unit 1041 detects the eyes of the passenger in the in-vehicle image (step S13). Various known detection methods are adoptable such as a method in which, by edge extracting, the outline of the eye is searched and a rectangular area including the eyes is extracted.

Subsequently, the line of sight detection unit 1041 detects the inner corners of eyes and irises from the image detected in step S13 that includes the eyes (step S14). Various known methods are adoptable such as a method for detecting inner corners of eyes and irises by the edge extracting.

And, the line of sight detection unit 1041 determines the line of sight of the passenger from a positional relationship between the inner corners of eyes and irises detected in step S 14 (step S15). Various known methods are usable in this operation such as, when the iris of the left eye is apart from the inner corner thereof, it is determined that the passenger looks toward the left side whereas when the inner corner of left eye is close to the iris thereof, it is determined that the passenger looks toward the right side. Based on this line of sight, at least a starting point position of the line of sight and a direction of the line of sight are acquired and taken as line-of-sight information. After determining the line of sight, the series of processes of the line of sight detection processing is ended, and then waits until the line of sight detection processing is started next.

### Processing of the Advertisement Detection Unit

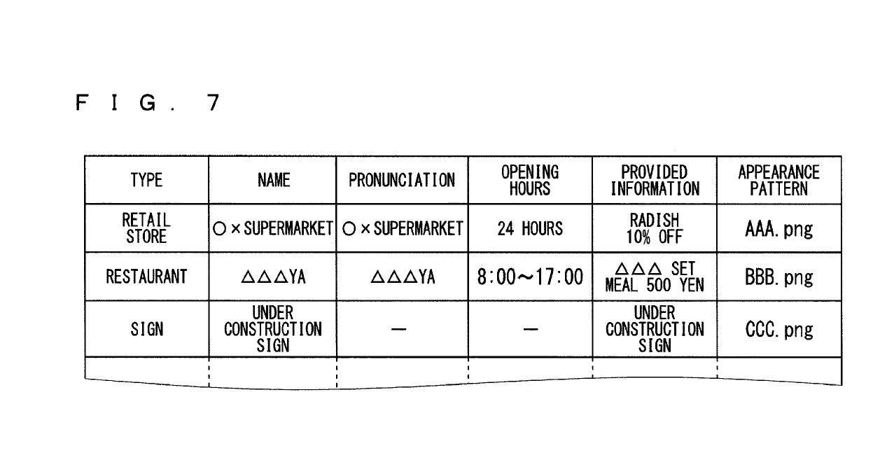

Next, advertisement detection processing by advertisement detection units 1051 and 1052 will be described with reference to a flowchart illustrated in FIG. 6. Operation performed in each of the advertisement detection units 1051 and 1052 is the same; therefore, the advertisement detection unit 1051 will be described below as an example.

The advertisement detection unit 1051 first acquires the load distribution plan from the data processing transfer unit 103, and determines, in the load distribution plan, whether or not the line of sight detection processing is assigned to the advertisement detection unit 1051 (step S21). When the result of determination is that the line of sight detection processing is assigned thereto, the step proceeds to step S22 whereas the line of sight detection processing is not assigned thereto, steps after step S22 are not executed and the processing is ended. This signifies that, of the advertisement detection units 1051 and 1052, only one of the units which is assigned the advertisement detection processing in the load distribution plan executes the advertisement detection processing.

In step S22, the advertisement detection unit 1051 acquires the external vehicle image and the parameters of the external vehicle image from the external image input unit 101.

Next, the advertisement detection unit 1051 acquires the line-of-sight information of the passenger from the line of sight detection unit 1041.

Subsequently, based on the starting point position of the line of sight and the direction of the line of sight included in the acquired line-of-sight information, an area in the external vehicle image that is viewed by the passenger (step S24). Hereinafter, the area will be referred to as a viewed area.

Next, the advertisement detection unit 1051 calculates the matching rate between the viewed area extracted in step S24 and an appearance pattern of the advertisement (step S25).

The image of the appearance pattern of the advertisement is stored, for example, for each advertisement in the advertisement DB 106, and matching between the advertisement of the viewed area and the image of the appearance pattern of the advertisement is performed by image recognition, and the matching rate of both is calculated. Here, the matching rate is calculated for each advertisement stored in the advertisement DB 106. As image recognition, there are various methods such as edge extraction, feature point extraction, etc. and any known method is adoptable in the present invention.

Next, the advertisement detection unit 1051 determines whether or not the highest matching rate among the matching rates calculated in step S25 is equal to or higher than a predetermined threshold (step S26). If the result is equal to or higher than the threshold, the step proceeds to step S27 whereas if the result is lower than the threshold, it is determined that no advertisement is detected and the processing is ended, and the following processes thereafter like those performed on the information output unit 107 are not executed. The threshold here may be set by the manufacturer of the information presentation system 100 or may be set by the user.

In step S27, the advertisement having the appearance pattern having the highest matching rate is specified as the advertisement (viewed target) which the passenger is viewing. After specifying the advertisement, the series of processes of the advertisement detection processing is ended, and then waits until the advertisement detection processing is started next.

The advertisement DB 106 stores detailed information on the advertisement as well as the image of the appearance pattern of the advertisement, and stores at least the name of the advertisement and provided information. It should be noted that, the advertisement DB 106 may be constructed in a memory or the like mounted on the vehicle VC, or, a database constructed in the server SV may be used. Also, the advertisement DB 106 may be configured to be updated to new information at any time.

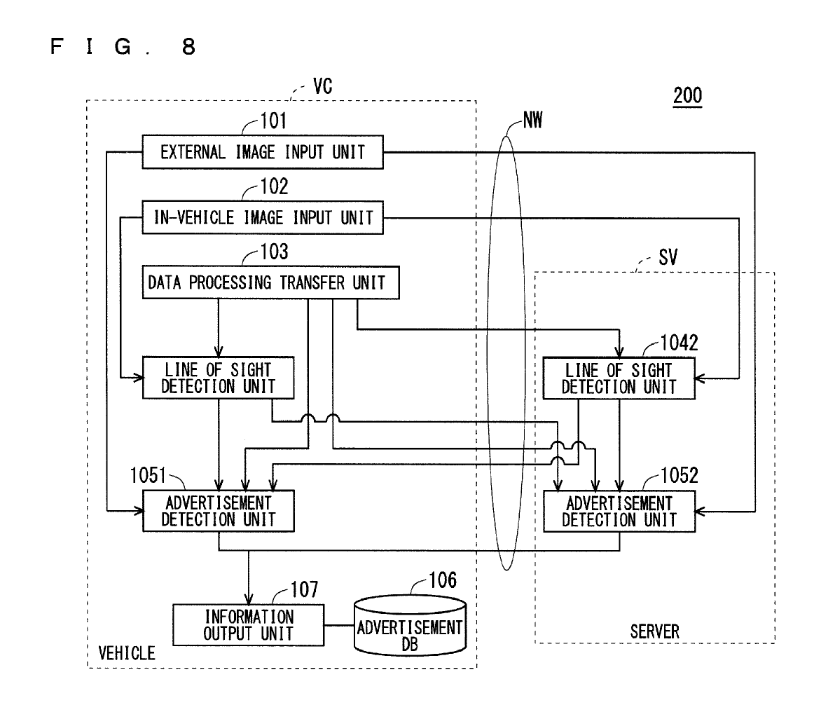

Here, an example of data stored in the advertisement DB 106 is illustrated in FIG. 7. As illustrated in FIG. 7, the advertisement DB 106 stores types of advertisements, names of advertisements, pronunciation of advertisements, opening hours, provided information, appearance patterns, and the like. Incidentally, as the types of advertisements, in addition to retail shops, restaurants, etc., signs indicating under construction are included. Also, although an example in which the appearance patterns are stored in bitmaps is illustrated, it is not limited thereto. Regarding the provided information, information such as discount rate, price, construction etc. is included, and the system developer may decide in advance.

In addition, although FIG. 5 illustrates an example in which the names of advertisements and the provided information are fixed, the provided information may be updated on a daily basis, or the latest information may be acquired, through the network NW, from a provider of the advertisement when referring to the advertisement DB 106.

Alternatively, the advertisement database DB 106 may not be constructed as an obvious database; a configuration in which hit contents from a search site in the Internet are stored as they are or the hit contents are abridged and stored therein may be adopted. That is, the appearance pattern of advertisements such as store signs, trademarks, logo marks, etc. are also displayed in a search site in the Internet, therefore, they are stored as appearance patterns, and catch phrases are stored as the provided information as they are or the catch phrases are abridged and stored therein, thereby a simple database can be created.

The information output unit 107 refers to the advertisement DB 106 for the advertisement specified by the advertisement detection unit 1051 (1502) and reads and outputs detailed information on the advertisement. In the example of FIG. 5, the provided information such as “a radish 10% OFF”, “ΔΔΔ set meal 500 yen”, “under construction sign” is acquired from the advertisement DB 106, and the provided information is provided to the passenger with an image and sound by using a display and a speaker constituting the information output unit 107. It should be noted that, the information output unit 107 may include a display and a speaker, however, a display and a speaker mounted on the vehicle VC may be used to output an image and sound.

Further, the information output unit 107 may present the information to a person who is not the passenger who views the advertisement. For example, a configuration may be adoptable in which the line of sight detection unit 1041 or 1042 acquires the line of sight of the driver, and a display and a speaker of a passenger seat and a back seat are connected to the information output unit 107, thereby the information is presented to a passenger in the passenger seat and passengers in the back seats.

Alternatively, the information presented by the information output unit 107 may be information other than the provided information of the advertisement database DB106. For example, both the opening hours and the provided information can be presented.

Further, the information output unit 107 may adopt a system in which the information is presented to a server, on a smartphone, and to the other vehicle. For example, the provided information of advertisement which is being viewed by the passenger may be transferred to a program on the server. As this program, a program for constructing a database such as what advertisement the passenger is interested in is considered.

Further, the provided information may be presented to a passenger in the other vehicle through the network NW. This ensures sharing of information with the passenger in the other vehicle.

According to the information presentation system 100, as described above, data processing can be executed by distributing the load between the inside of the vehicle VC and the server SV, therefore, time-consuming processing in the vehicle VC such as image recognition processing, for example, is executed by using processing capability of the server SV, thereby shortening the time for processing.

Further, the load distribution plan is set based on the states of the vehicle VC, the server SV, and the network NW (communication), thereby shortening the processing time in total.

### Embodiment 2

In the information presentation system 100 according to Embodiment 1 described above, load distribution is performed with an alternative method in which the line of sight detection processing and the advertisement detection processing are executed by either the vehicle VC or the server SV, however, the load distribution may be performed by sharing the line of sight detection processing and the advertisement detection processing by the vehicle VC and the server SV.

### Device Configuration

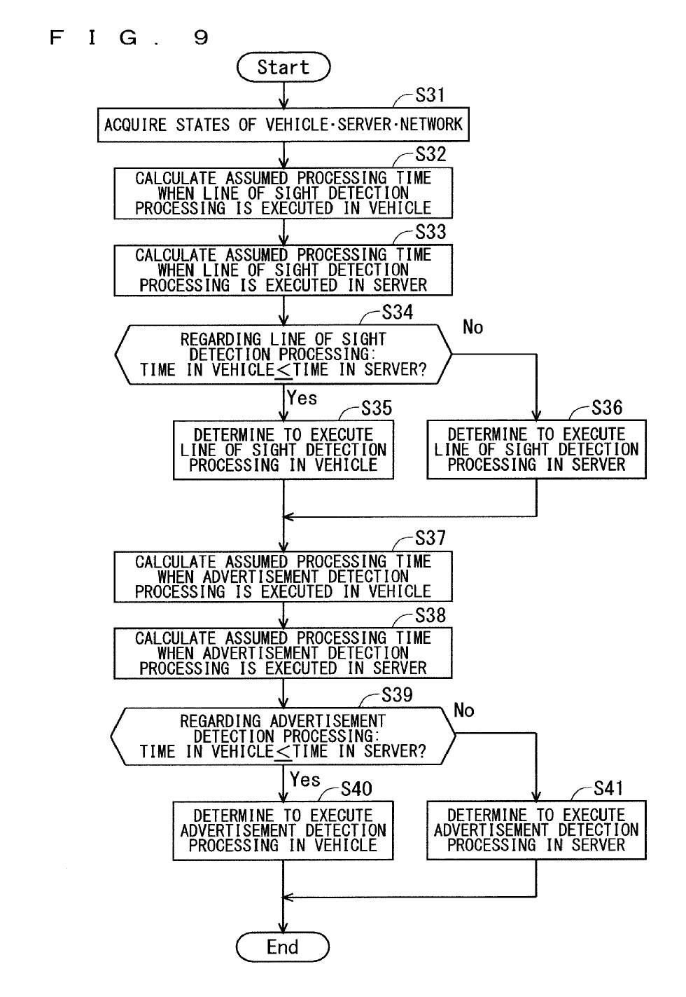

FIG. 8 is a block diagram illustrating a configuration of an information presentation system 200 according to Embodiment 2 of the present invention. It should be noted that, the same components as those of the information presentation system 100 described with reference to FIG. 1 are denoted by the same reference numerals, and overlapping descriptions are omitted.

As illustrated in FIG. 8, the information presentation system 200 has a configuration in which the line-of-sight information detected in the line of sight detection unit 1041 in the vehicle VC is also output to the advertisement detection unit 1052 in the server SV and the line-of-sight information detected in the line of sight detection unit 1042 in the line of sight detection unit 1042 is also output to the advertisement detection unit 1052 in the vehicle VC. The data processing transfer unit 103 sets, based on the states of the vehicle VC, the server SV, and the network NW (communication), the load distribution plan in which the vehicle VC is caused to execute the line of sight detection processing and the server SV is caused to execute the advertisement detection processing, or, the server SV is caused to execute the line of sight detection processing and the vehicle VC is caused to execute the advertisement detection processing.

### Processing in the Data Processing Transfer Unit

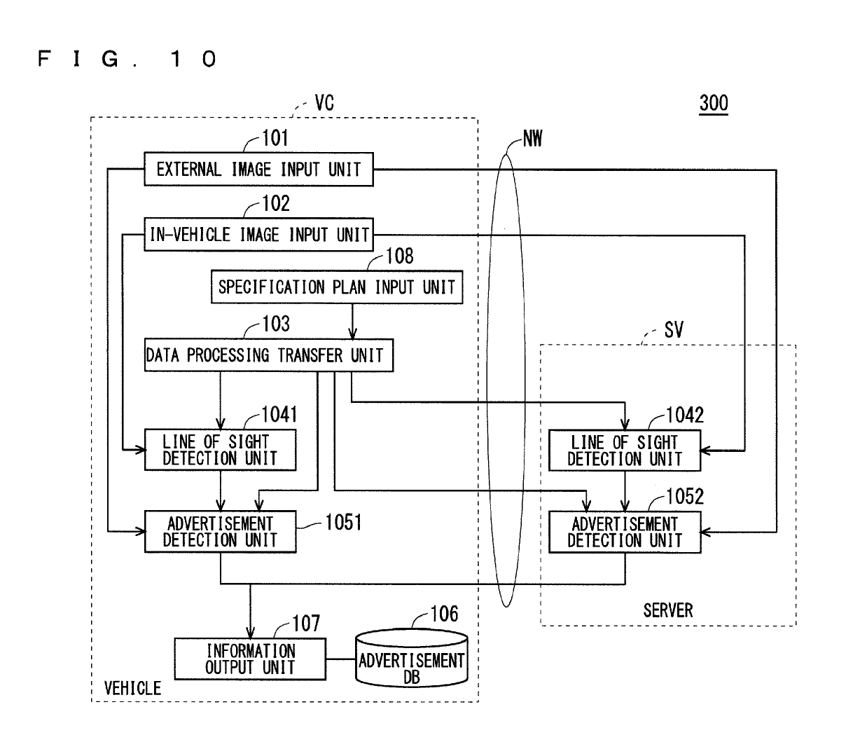

Next, transfer processing of the data processing transfer unit 103 will be described with reference to a flowchart illustrated in FIG. 9.

When the processing at the data processing transfer unit 103 starts, first, the data processing transfer unit 103 acquires the states of the vehicle VC, the server SV, and the network NW (communication) (step S31). The states of the vehicle VC acquired by the data processing transfer unit 103 includes an upper limit of the processing capacity of the CPU in the vehicle VC, a processing capability of the CPU having a margin in the processing capacity within the current vehicle VC, an upper limit of the capacity of the memory in the vehicle VC usable in the transfer processing, a storage capacity of the memory in the storage capacity of the current vehicle VC, presence or absence of processes and programs in the vehicle VC operating in parallel with the transfer processing and so forth.

The states of the server SV acquired by the data processing transfer unit 103 includes an upper limit of the processing capacity of the CPU in the server SV, a processing capability of the CPU having a margin in the processing capacity within the current server SV, an upper limit of the storage capacity of the memory in the server SV usable in the transfer processing, a storage capacity of the memory in the storage capacity of the current server SV, presence or absence of processes and programs in the server SV operating in parallel with the transfer processing and so forth.

The states of the communication (network NW) acquired by the data processing transfer unit 103 include an upper limit of the communication speed, the current communication speed, a communication amount currently used in other processing and program, one-way or a round-trip communication time between the current vehicle VC and the server SV, and so forth.

Next, the data processing transfer unit 103 calculates an assumed processing time when the line of sight detection processing is executed in the vehicle VC by using the state of the vehicle VC acquired in step S31 (step S32).

For example, when it is assumed that the processing amount required for transfer processing is 500 [% sec] and the currently usable processing capability of the CPU in the vehicle VC acquired in step S1 is 100%, it takes 500÷100=5[sec] in the assumed processing time.

Next, the data processing transfer unit 103 calculates an assumed processing time when the line of sight detection processing is executed in the server SV by using the state of the server SV acquired in step S31 (step S33).

For example, when it is assumed that the processing amount required for line of sight detection processing is 500 [% sec] and the currently usable processing capability of the CPU in the server SV acquired in step S1 is 200%, it takes 500÷200=2.5 [sec] in the assumed processing time. And when it takes 2 [sec] for the round-trip communication time between the vehicle VC and the server SV acquired in step S1, it takes 2.5+2=4.5 [sec] to complete the processing, therefore, time necessary for communication is taken into consideration.

Next, the data processing transfer unit 103 compares the assumed processing times in the vehicle VC calculated in step S32 with the assumed processing times in the server SV calculated in steps S33 (step S34). And when the result is that the line of sight detection processing time in the vehicle VC is equal to or lower than the line of sight detection processing time in the server SV, the step proceeds to step S35, while when the result is that the line of sight detection processing time in the vehicle VC exceeds the line of sight detection processing time in the server SV, the step proceeds to step S36.

That is, when the line of sight detection processing time in the vehicle VC is equal to or lower than the line of sight detection processing time in the server SV, the data processing transfer unit 103 determines a load distribution plan of execution of the line of sight detection processing in the vehicle VC (step S35). Therefore, the line of sight detection processing is executed in the line of sight detection unit 1041. Meanwhile, when the line of sight detection processing time in the vehicle VC exceeds the line of sight detection processing time in the server SV, the data processing transfer unit 103 determines a load distribution plan of execution of the line of sight detection processing in the server SV (step S36). Therefore, the line of sight detection processing is executed in the line of sight detection unit 1042.

Next, the data processing transfer unit 103 calculates an assumed processing time when the advertisement detection processing is executed in the vehicle VC by using the state of the vehicle VC acquired in step S31 (step S37).

For example, when it is assumed that the processing amount required for the advertisement detection processing is 1000 [% sec] and the currently usable processing capacity of the CPU in the vehicle VC acquired in step S31 is 100%, it takes 1000÷100=10 [sec] in the assumed processing time.

Next, the data processing transfer unit 103 calculates an assumed processing time when the advertisement detection processing is executed in the server SV by using the states of the server SV and the communication acquired in step S31 (step S38).

For example, when it is assumed that the processing amount required for the advertisement detection processing is 1000 [% sec] and the currently usable processing capacity of the CPU in the server SV acquired in step S31 is 200%, it takes 1000÷200=5 [sec] in the assumed processing time. And when it takes 2 [sec] for the round-trip communication time between the vehicle VC and the server SV acquired in step S31, it takes 5+2=7 [sec] to complete the processing, therefore, time necessary for communication is taken into consideration.

Next, the data processing transfer unit 103 compares the assumed processing times in the vehicle VC calculated in step S37 with the assumed processing times in the server SV calculated in steps S38 (step S39). And when the result is that the advertisement detection processing time in the vehicle VC is equal to or lower than the advertisement detection processing time in the server SV, the step proceeds to step S40, while when the result is that the advertisement detection processing time in the vehicle VC exceeds the advertisement detection processing time in the server SV, the step proceeds to step S41.

That is, when the advertisement detection processing time in the vehicle VC is equal to or lower than the advertisement detection processing time in the server SV, the data processing transfer unit 104 determines a load distribution plan of execution of the advertisement detection processing in the vehicle VC (step S40). Therefore, the advertisement detection processing is executed in the advertisement detection unit 1051. Meanwhile, when the advertisement detection processing time in the vehicle VC exceeds the advertisement detection processing time in the server SV, the data processing transfer unit 103 determines a load distribution plan of execution of the advertisement detection processing in the server SV (step S41). Therefore, the advertisement detection processing is executed in the advertisement detection unit 1052.

The data processing transfer unit 103 performs determination in step S40 and step S41, then completes a series of steps of the transfer processing, and waits until the transfer processing is started next.

According to the information presentation system 200, as described above, the load distribution plan in which the vehicle VC is caused to execute the line of sight detection processing and the server SV is caused to execute the advertisement detection processing, or, the server SV is caused to execute the line of sight detection processing and the vehicle VC is caused to execute the advertisement detection processing is set. This enables to execute data processing by distributing the load between the inside of the vehicle VC and the server SV, therefore, based on the states of the vehicle VC, the server SV, and the network NW (communication), the total processing time is shortened.

### Modification 1

In the information presentation system 200 as described above, the assumed processing time of the advertisement detection processing is calculated after the determination of whether to execute the line of sight detection processing in in the vehicle VC or in the server SV. Therefore, upon calculation of the advertisement detection processing, the assumed processing time may be calculated by reflecting the determination result of the line of sight detection processing.

For example, when it is determined in step S36 that the line of sight detection processing is executed by the server SV, the execution of the line of sight detection processing uses the processing capability (processing capacity of the CPU, capacity of the memory) of the server SV, accordingly, it can be considered that the processing capability of the server SV is lowered than that of the server SV when the state thereof is acquired in step S31. If the advertisement detection processing is assigned as it is, there is a possibility that the advertisement detection processing is to be assigned to the server SV in step S41 through step S39 despite the processing capability of the server SV being lowered. Therefore, in step S38, the assumed processing time is calculated with a processing capability obtained by subtracting the processing capability required for executing the line of sight detection processing from the processing capability of the server SV acquired in step S31. As a result, an assumed processing time more suitable for the reality can be calculated, and proper assignment is ensured. It should be noted that, the above procedure can also be adopted similarly to the case where it is determined in step S36 to execute the line of sight detection processing in the vehicle CV.

### Modification 2

In the information presentation system 200 and Modification 1 described above, the line of sight detection processing and the advertisement detection processing are separately determined to be executed in the vehicle VC or in the server SV. However, executing destinations may be determined for each processing unit in the line of sight detection processing and the advertisement detection processing.

Specifically, in the case where each of the steps S12 to S15 in FIG. 5 illustrating the line of sight detection processing and each of the steps S22 to S27 in FIG. 6 illustrating the advertisement detection processing are defined as a processing unit, for example, the process of step S12 may be executed in the vehicle VC and the process of step S13 may be executed in the server SV.

In this case, the processes of steps S32 and S33 illustrated in the flowchart of FIG. 9 are processes for calculating the assumed processing time for each of the steps S12 to S15 whereas the processes of steps S34 to S36 are processes for determining whether to be executed by the vehicle VC or the server SV for each of the steps S12 to S15.

Similarly, the processes of steps S37 and S38 illustrated in the flowchart of FIG. 9 are processes for calculating the assumed processing time for each of the steps S22 to S27 whereas the processes of steps S39 to S41 are processes for determining whether to be executed by the vehicle VC or the server SV for each of the steps S22 to S27.

Meticulous assignment commensurate with the processing capability of the vehicle VC and the processing capability of the server SV is ensured by determining execution destinations for each processing unit.

### Embodiment 3

### Device Configuration

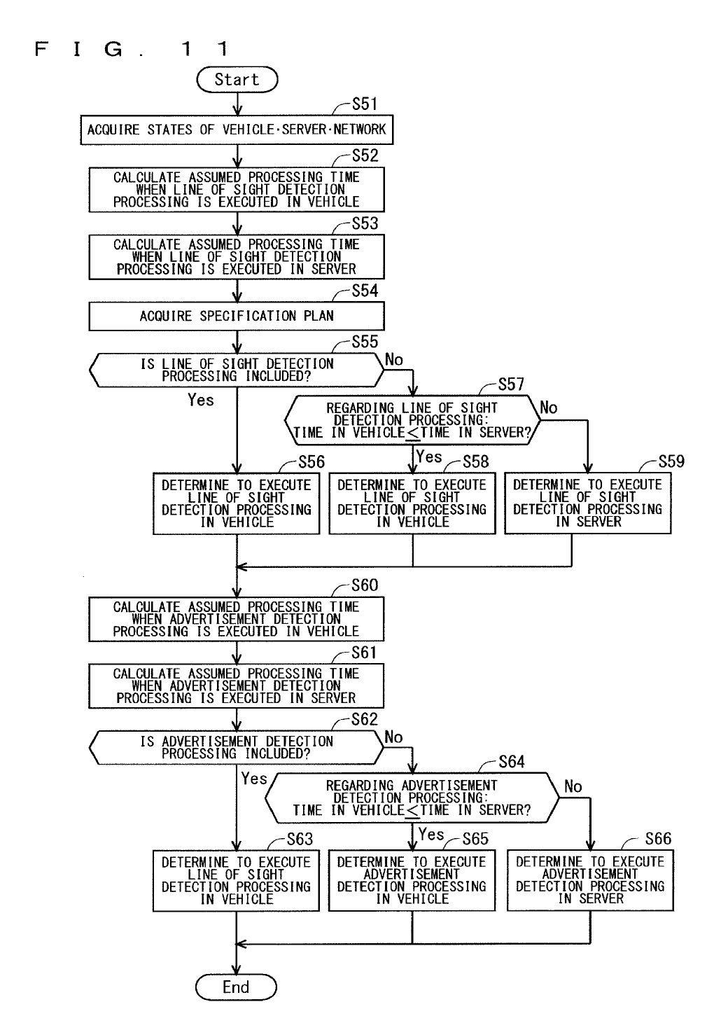

FIG. 10 is a block diagram illustrating a configuration of an information presentation system 300 according to Embodiment 3 of the present invention. It should be noted that, the same components as those of the information presentation system 100 described with reference to FIG. 1 are denoted by the same reference numerals, and overlapping descriptions are omitted.

As illustrated in FIG. 10, the information presentation system 300 includes a specification plan input unit 108 configured to set a specification plan in which a process not related to the load distribution plan is previously specified, when the data processing transfer unit 103 set the load distribution plan.

Information of the specification plan set by the specification plan input unit 108 is output to the data processing transfer unit 103. When the load distribution plan is set in the data processing transfer unit 103, the data processing transfer unit 103 is to use the information of the specification plan output from the specification plan input unit 108 in addition to the states of the vehicle VC, the server SV, and the network NW (communication). The specification plan can be set by a system developer in consideration of processing efficiency.

### Processing in the Data Processing Transfer Unit

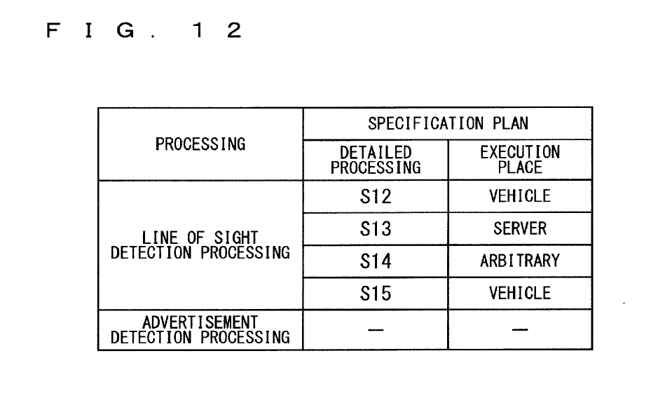

Next, transfer processing of the data processing transfer unit 103 will be described with reference to a flowchart illustrated in FIG. 11.

When the processing at the data processing transfer unit 103 starts, first, the data processing transfer unit 103 acquires the states of the vehicle VC, the server SV, and the network NW (communication) (step S51).

Next, the data processing transfer unit 103 calculates an assumed processing time when the line of sight detection processing is executed in the vehicle VC by using the state of the vehicle VC acquired in step S51 (step S52).

Next, the data processing transfer unit 103 calculates an assumed processing time when the line of sight detection processing is executed in the server SV by using the state of the server SV acquired in step S51 (step S53).

And, the data processing transfer unit 103 acquires information of the specification plan set by the specification plan input unit 108 (step S54).

And, the data processing transfer unit 103 determines whether the line of sight detection processing is included in the specification plan acquired in step S54. When the result is that the line of sight detection processing is included therein, the step proceeds to step S56 and when the result is that the line of sight detection processing is not included therein, the step proceeds to step S57.

Here, an example of a specification plan is illustrated in FIG. 12. In FIG. 12, the case where the line of sight detection processing is included in the specification plan is illustrated and the advertisement detection processing is not included. And, processes of steps S12 to S15 (FIG. 5) of the line of sight detection processing are included as detailed processing, of these, processes of steps S12 and S15 are specified to be executed in the vehicle VC and a process of step S13 is specified to be executed in the server SV, and in a process of step S14, the execution place is not specified and remains arbitrary. Here, “arbitrary” means that it may be executed by either of the vehicle VC and the server SV, however, it is more efficient to execute successive steps at the same place as much as possible, therefore, it is considered that if step S13 is executed by the server SV, step S14 is executed by the server SV.

The data processing transfer unit 103 determines that the line of sight detection processing is included in information of the specification plan when even one process of which execution place is specified to the vehicle VC or the server SV. The data processing transfer unit 103 determines that the line of sight detection processing is not included in the information of the specification plan when neither the vehicle VC nor the server SV are specified as the execution place, for example, the execution places for all processes are arbitrary.

In step S56, the data processing transfer unit 103 determines that the execution place of the line of sight detection processing is the vehicle CV or the server SV based on the information of the specification plan acquired in step S54. In this case, executing destinations can be determined for each processing unit in the line of sight detection processing in accordance with the specification plan.

Meanwhile, when the step proceeds to step S57, the data processing transfer unit 103 compares the assumed processing times in the vehicle VC calculated in step S52 with the assumed processing times in the server SV calculated in steps S53. And when the result is that the line of sight detection processing time in the vehicle VC is equal to or lower than the line of sight detection processing time in the server SV, the step proceeds to step S58, while when the result is that the line of sight detection processing time in the vehicle VC exceeds the line of sight detection processing time in the server SV, the step proceeds to step S59.

That is, when the line of sight detection processing time in the vehicle VC is equal to or lower than the line of sight detection processing time in the server SV, the data processing transfer unit 103 determines a load distribution plan of execution of the line of sight detection processing in the vehicle VC (step S58). Therefore, the line of sight detection processing is executed in the line of sight detection unit 1041. Meanwhile, when the line of sight detection processing time in the vehicle VC exceeds the line of sight detection processing time in the server SV, the data processing transfer unit 103 determines a load distribution plan of execution of the line of sight detection processing in the server SV (step S59). Therefore, the line of sight detection processing is executed in the line of sight detection unit 1042.

Next, the data processing transfer unit 103 calculates an assumed processing time when the advertisement detection processing is executed in the vehicle VC by using the state of the vehicle VC acquired in step S51 (step S60).

Next, the data processing transfer unit 103 calculates an assumed processing time when the advertisement detection processing is executed in the server SV by using the states of the server SV and the communication acquired in step S51 (step S61).

And, the data processing transfer unit 103 determines whether the advertisement detection processing is included in the specification plan acquired in step S54. When the result is that the line of sight detection processing is included therein, the step proceeds to step S63 and when the result is that the line of sight detection processing is not included therein, the step proceeds to step S64. It should be noted that the determination of whether the advertisement detection processing is included in the specification plan is the same as the determination of whether the line of sight detection processing is included described in step S55, therefore, the description thereof is omitted.

In step S63, the data processing transfer unit 103 determines that the execution place of the advertisement detection processing is the vehicle CV or the server SV based on the information of the specification plan acquired in step S54. In this case, executing destinations can be determined for each processing unit in the advertisement detection processing in accordance with the specification plan.

Meanwhile, when the step proceeds to step S64, the data processing transfer unit 103 compares the assumed processing times in the vehicle VC calculated in step S60 with the assumed processing times in the server SV calculated in steps S61. And when the result is that the advertisement detection processing time in the vehicle VC is equal to or lower than the advertisement detection processing time in the server SV, the step proceeds to step S65, while when the result is that the advertisement detection processing time in the vehicle VC exceeds the advertisement detection processing time in the server SV, the step proceeds to step S66.

That is, when the advertisement detection processing time in the vehicle VC is equal to or lower than the advertisement detection processing time in the server SV, the data processing transfer unit 103 determines a load distribution plan of execution of the advertisement detection processing in the vehicle VC (step S65). Therefore, the advertisement detection processing is executed in the advertisement detection unit 1051. Meanwhile, when the advertisement detection processing time in the vehicle VC exceeds the advertisement detection processing time in the server SV, the data processing transfer unit 103 determines a load distribution plan of execution of the advertisement detection processing in the server SV (step S66). Therefore, the advertisement detection processing is executed in the advertisement detection unit 1052.

The data processing transfer unit 103 performs determination in step S63, step S65, or step S66, then completes a series of steps of the transfer processing, and waits until the transfer processing is started next.

As described above, according to the information presentation system 300, a place for at least one process in the line of sight detection processing and the advertisement detection processing is executed can be specified to the vehicle VC or the server SV. Therefore, determination, by the load distribution plan, for the processes which are efficiently executed in a fixed manner in one of the vehicle VC and the server SV, is eliminated so that the time for setting the load distribution plan can be shortened and the whole processing time can be shortened.

### Modification

In the example of the specification plan shown in FIG. 12, the execution place of the line of sight detection processing is set for each processing unit in the line of sight detection processing, however, the execution places for all of processing units of the line of sight detection processing and the advertisement detection processing can also be collectively set.

Therefore, specification of executing destination for each processing unit is eliminated and setting the specification plan is facilitated.

While the invention has been described in detail, the foregoing description is in all aspects illustrative and not restrictive and the invention is not limited thereto. It is understood that numerous other modifications and variations can be devised without departing from the scope of the invention.

It should be noted that Embodiments of the present invention can be arbitrarily combined and can be appropriately modified or omitted without departing from the scope of the invention.

1. An information presentation system configured to present provided information related to an advertisement outside a vehicle viewed by a passenger of the vehicle,
the information presentation system being configured to transfer and receive data through a network between the vehicle and a server provided outside the vehicle,
the vehicle including
an external image input unit to which an external image is input,
an in-vehicle image input unit to which an in-vehicle image is input,
a data processing transfer unit configured to set a load distribution plan to distribute data processing to the vehicle and the server based on a state of the vehicle, a state of the server, and a state of the network,
a first line of sight detection unit configured to detect a line of sight of the passenger based on the in-vehicle image acquired from the in-vehicle image input unit,
a first advertisement detection unit configured to specify the advertisement viewed by the passenger based on the line of sight of the passenger and the external image and parameters of the external image acquired from the external image input unit,
a database in which an appearance pattern and the provided information of the advertisement are stored, and
an information output unit configured to output the provided information stored in the database,
the server including
a second line of sight detection unit configured to detect a line of sight of the passenger based on the in-vehicle image acquired from the in-vehicle image input unit, and
a second advertisement detection unit configured to specify the advertisement viewed by the passenger based on the line of sight of the passenger and the external image acquired from the external image input unit,
the first and second advertisement detection units being configured to perform matching between the external image and the appearance pattern of the advertisement stored in the database to specify the advertisement viewed by the passenger.

2. The information presentation system according to claim 1, wherein
the data processing transfer unit is configured to,
as the state of the vehicle, acquire a load of a processor and a load of a memory on the vehicle side,
as the state of the server, acquire a load of a processor and a load of a memory on the server side,
as the state of the network, acquire a communication speed of the network, and, based on at least of one of the states, and set the load distribution plan to shorten a processing time for line of sight detection processing and advertisement detection processing.

3. The information presentation system according to claim 2, wherein
the data processing transfer unit is configured to
set the load distribution plan such that the first line of sight detection unit is caused to execute the line of sight detection processing and the first advertisement detection unit is caused to execute the advertisement detection processing, or the second line of sight detection unit is caused to execute the line of sight detection processing and the second advertisement detection unit is caused to execute the advertisement detection processing.

4. The information presentation system according to claim 2, wherein
the data processing transfer unit is configured to
set the load distribution plan such that one of the first and the second line of sight detection units is caused to execute the line of sight detection processing and one of the first and the second advertisement detection units is caused to execute the advertisement detection processing.

5. The information presentation system according to claim 2, wherein
the data processing transfer unit is configured to,
for each processing unit constructing the line of sight detection processing, distribute a process to at least one of the first and the second line of sight detection units, and
for each processing unit constructing the advertisement detection processing, distribute a process to at least one of the first and the second line of sight detection units.

6. The information presentation system according to claim 2,
wherein the vehicle further includes
a specification plan input unit configured to set a specification plan in which data processing not related to the load distribution plan is previously determined,
wherein the specification plan is configured to,
for each processing unit constructing the line of sight detection processing, specify an executing destination to one of the first and the second line of sight detection units, and
for each processing unit constructing the advertisement detection processing, specify an executing destination to one of the first and the second line of sight detection units, and
wherein the data processing transfer unit is configured to,
when the specification plan is set, distribute data processing to the vehicle and the server based on the specification plan.

7. The information presentation system according to claim 2,
wherein the vehicle further includes
a specification plan input unit configured to set a specification plan in which data processing not related to the load distribution plan is previously determined,
wherein the specification plan is configured to
specify an executing destination for the line of sight detection processing as a whole to one of the first and the second line of sight detection units, and
specify an executing destination for the advertisement detection processing as a whole to one of the first and the second advertisement detection units, and
wherein the data processing transfer unit is configured to,
when the specification plan is set, distribute data processing to the vehicle and the server based on the specification plan.

8. The information presentation system according to claim 1, wherein
the information output unit is configured to
output the provided information to at least one of the vehicle and another vehicle.
